(19) United States
(12) Patent Application Publication
(10) Pub. No.: US 2016/0027331 A1
(43) Pub. Date: Jan. 28, 2016

(54) Method for providing a mobile device with report data of a measurement apparatus

(71) Applicant: Rohde & Schwarz GmbH & Co. KG, Munchen (DE)

(72) Inventor: Chow-Han Ding, Singapore (SG)

(21) Appl. No.: 14/341,058

(22) Filed: Jul. 25, 2014

(51) Int. Cl. G09B 19/02; H04W 4/00; H04W 4/02

(52) U.S. Cl. CPC G09B 19/02; H04W 4/023; H04W 4/008

(57) ABSTRACT

A stationary measurement apparatus for providing a mobile device with report data transmitted automatically via at least one wireless link from said stationary measurement apparatus to the mobile device if a proximity detection unit of said measurement apparatus detects that the mobile device is in the vicinity of the stationary measurement apparatus.

### FIELD OF THE INVENTION

The present invention relates to a method for providing a mobile device with report data of a measurement apparatus, and in particular to a training method for providing a mobile device of a lecturer with report data of a measurement apparatus operated by a technician to be trained by the lecturer.

### BACKGROUND OF THE INVENTION

As the complexity of measurement apparatuses increases, it becomes difficult to check the performance of the measurement apparatus or measurement devices during operation and/or the performance of technicians handling the measurement apparatuses. For instance, in a production line comprising a plurality of measurement devices handled by different technicians, it is difficult for a supervising person to check the performance of the measurement devices. For such a supervising person, it is difficult to allocate the measurement devices within the production facility and to associate received report data with measurement apparatuses in the production facility. The supervising technician has first to find a measurement apparatus within the location of the production facility, read measurement data results, and forward the read-out measurement results via an interface of the measurement apparatus. The supervisory technician has to locate the measurement apparatus and to set up a data connection for loading measurement results or report data from the identified measurement apparatus. This is very cumbersome for the supervisory technician and prone to faults, because the supervisory technician may confuse measurement devices when reading a plurality of measurement devices within a production facility.

Since the complexity of measurement devices increases and requires training, technicians or users working in a production facility or research laboratory undergo training by a trainer or lecturer in a training facility or in a laboratory. For training purposes, the measurement apparatus is connected to a measurement setup and the technician to be trained operates the measurement apparatus via a user interface to perform test measurements. The test measurement generates test measurement results such as signal diagrams or tables of measurement parameters. Accordingly, the lecturer or trainer gets a report from the trained technician showing his measurement results in a text document. This conventional way of teaching trainees is also cumbersome for the lecturer and does not allow report data provided by different technicians to be compared with each other automatically. Furthermore, it is difficult for the lecturer to identify, whether each technician has provided him with a specific report text document.

Consequently, there is a need to provide a more comfortable but nevertheless reliable way for providing a supervising person with report data of a measurement apparatus.

### SUMMARY OF THE INVENTION

The present invention provides a method and apparatus for supplying a mobile device with report data, in particular a training system for training technicians to handle a measurement apparatus.

Specifically, according to a first aspect of the present invention, a stationary measurement apparatus is provided for providing a mobile device with report data transmitted automatically via at least one wireless link from the measurement apparatus to the mobile device, if it is detected that the mobile device is in the vicinity of the stationary measurement apparatus.

According to a second aspect of the present invention, a mobile device is provided, said mobile device comprising a wireless transceiver adapted to receive via at least one wireless link report data transmitted automatically by a stationary measurement apparatus to the mobile device upon detection of the presence of the mobile device in the vicinity of the measurement apparatus.

According to a third aspect of the present invention, a method, in particular a training method, for providing a mobile device with report data of a measurement apparatus is provided, the method comprising: detecting the presence of the mobile device within the vicinity of the stationary measurement apparatus, and transmitting automatically report data via at least one wireless link from the stationary measurement apparatus to the mobile device upon detection of the presence of the mobile device within a predetermined radius.

According to a fourth aspect of the present invention, a training system for training technicians to handle a measurement apparatus is provided, wherein each technician has an associated measurement apparatus to perform measurements during training, wherein said measurement apparatus is configured to trigger a wireless transceiver of the measurement apparatus to transmit automatically report data related to the performed training via at least one wireless link to the mobile device of a lecturer if the presence of the lecturer's mobile device in the vicinity of the measurement apparatus is detected.

According to a fifth aspect of the present invention, a computer readable program product is provided, the computer readable program product comprising instructions which, when executed on a programmable circuit, detect the presence of a mobile device within the vicinity of a stationary measurement apparatus and transmit automatically report data via at least one wireless link from the stationary measurement apparatus to the mobile device upon detection of the presence of the mobile device within the vicinity of the measurement apparatus. In one embodiment, the computer readable program product includes one or more non-transitory computer readable media on which the instructions are stored.

An idea underlying the present invention is the use of a simple mobile device such as a smartphone to receive automatically report data from a complex stationary measurement apparatus of measurement equipment such as an oscilloscope, a signal generator, a signal analyzer, a network analyzer and/or a testing device. With the present invention, it is possible to facilitate the evaluation of report data received from a plurality of measurement devices within a production facility and/or research facility to improve the training of technicians handling these measurement devices in such a facility.

Specific embodiments of the different aspects of the present invention are set forth in the dependent claims.

These and other aspects of the present invention will be apparent from and elucidated with reference to the embodiments described hereinafter.

### BRIEF DESCRIPTION OF THE FIGURES

For a more complete understanding of the present invention and advantages thereof, reference is now made to the following description taken in conjunction with the accompanying drawings. Different aspects of the present invention are explained in more detail below using exemplary embodiments which are specified in the schematic figures in which:

FIG. 1 schematically shows a block diagram of a system comprising a measurement apparatus and a mobile device according to a specific embodiment of the present invention;

FIG. 2 shows a schematic diagram for illustrating an exemplary embodiment of a training system according to a further aspect of the present invention;

FIG. 3, 4, 5, 6 schematically show signal diagrams for illustrating different embodiments of the method for providing a mobile device with report data of a measurement apparatus according to an aspect of the present invention;

FIG. 7 shows a simple flow chart illustrating a possible exemplary embodiment of a method according to the present invention.

In the figures, the drawing elements, features and signals which are the same or at least have the same functionality have been provided with the same reference symbols, unless explicitly stated otherwise.

### DETAILED DESCRIPTION OF THE EMBODIMENTS

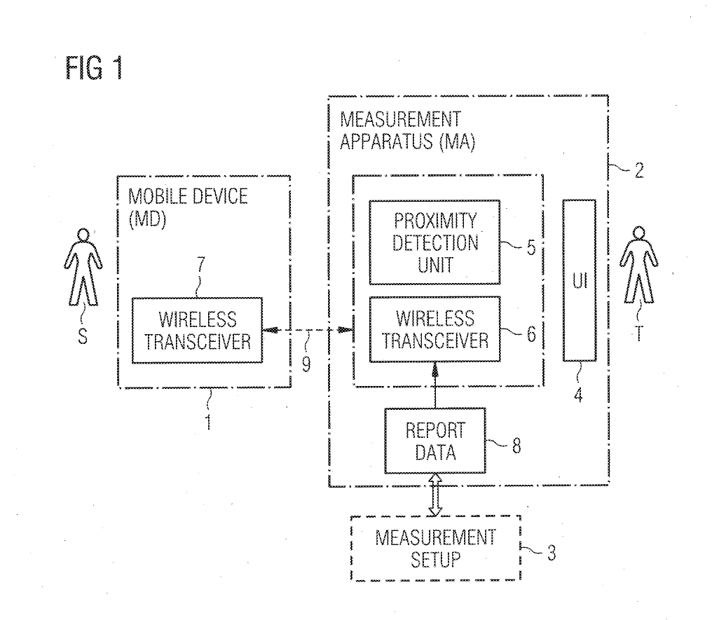

FIG. 1 illustrates schematically a system according to an aspect of the present invention comprising a mobile device 1, such as a mobile phone, smartphone or laptop, carried by a supervisory person S such as a supervisory technician in a production line or a lecturer L in a training lab. The system shown in FIG. 1 further comprises a measurement apparatus 2 to perform measurements at a measurement or test setup 3. The measurement apparatus 2 can be a complex measurement apparatus 2 such as an oscilloscope, a signal generator, a signal analyzer, a network analyzer and/or a testing device. The measurement apparatus 2 can form part of a production line within a production facility or can be located in a training facility or training lab. The measurement apparatus 2 is in a possible embodiment a training measurement apparatus 2 configured to perform training sessions for a technician. The measurement apparatus 2 is in a possible embodiment a high frequency, HF, measurement apparatus. The measurement apparatus 2 comprises a user interface UI 4, in particular a graphical user interface 4 which allows a technician T to perform measurements at the measurement setup 3. For instance, the technician T can perform measurements at the measurement setup 3 to generate signal diagrams showing control and response signals of electronic components within the measurement setup 3.

The stationary measurement apparatus 2 comprises in a possible embodiment proximity detection unit 5 which can be integrated in a wireless transceiver 6 of the measurement apparatus 2 as illustrated in FIG. 1. The proximity detection unit 5 and the wireless transceiver 6 can form an integrated unit. This unit can form part of a tag connected to the measurement apparatus 2. In a possible embodiment the integrated unit comprising the proximity detection unit 5 and the wireless transceiver 6 is located outside a high frequency, HF, shield protecting an internal measurement circuitry of the measurement apparatus 2 from external high frequency signal having a high frequency of more than 2 MHz. The mobile device 1 carried by the supervisory person S or lecturer L comprises a wireless transceiver 7 which can communicate with the other wireless transceiver 6 integrated or connected to the measurement apparatus 2. The communication between the wireless transceivers 6, 7 is in a preferred embodiment bidirectional. The wireless transceivers 6, 7 provide a wireless transmission link between the mobile device 1 and the measurement apparatus 2. In an alternative embodiment, more than one wireless link can be provided between the mobile device 1 and the measurement apparatus 2. The proximity detection unit 5 is configured to detect when the mobile device 1 is within the vicinity of the stationary measurement apparatus 2. In a possible embodiment the proximity detection unit 5 is integrated in the measurement apparatus 2. In an alternative embodiment the proximity detection unit forms part of the mobile device 1. In a possible embodiment, the proximity detection unit 5 detects the presence of the mobile device 1 in a predetermined range or radius of the measurement apparatus 2. In a possible embodiment, the proximity detection unit 5 is configured to generate an internal trigger signal as soon as the mobile device 1 is within a predetermined radius R of the measurement apparatus 2 and the generated trigger signal is supplied by the proximity detection unit 5 to the wireless transceiver 6 of the measurement apparatus 2 to automatically push report data RD stored in an internal memory 8 of the measurement apparatus 2 via the wireless link 9 to the wireless transceiver 7 of the mobile device 1. The data memory 8 of the measurement apparatus 2 can store in a possible exemplary embodiment an instrument setup of the measurement apparatus 2 or measurement results generated by the measurement apparatus 2 during a measurement operation. In a possible embodiment, the report data RD stored in the data memory 8 can also include a text document generated by the technician T during performing the measurement operation at the measurement setup 3. In a possible embodiment, the data memory 8 can be integrated in the measurement apparatus 2. In an alternative embodiment, the data memory 8 is connected to the measurement apparatus 2 via a data interface. In a possible embodiment, the data memory 8 can comprise a data card or data memory stick. In a possible embodiment, the presence of the mobile device 1 in the vicinity of the measurement apparatus 2 is detected by a wireless near field communication, NFC, between the mobile device 1 and the proximity detection unit 5 which can be integrated in the wireless transceiver 6 of the measurement apparatus 2. After detection of the mobile device 1 in the vicinity of the measurement apparatus 2, by a near field communication, NFC, a wireless Bluetooth connection between the wireless transceiver 6 of the measurement apparatus 2 and the wireless transceiver 7 of the mobile device 1 can be automatically established to transmit the report data RD stored in the data memory 8 via the established Bluetooth connection from the measurement apparatus 2 to the mobile device 1. In a possible embodiment, after successful transmission of the report data RD to the mobile device 1, the Bluetooth connection can be automatically disabled. In an alternative embodiment, the NFC communication for detecting the presence of the mobile device 1 in the vicinity of the measurement apparatus 2 can be performed between an NFC device and an unpowered NFC tag. After having detected the presence of the mobile device 1 in the vicinity of the measurement apparatus 2, the proximity detection unit 5 can enable a Bluetooth connection on both devices, instantly pair both devices and disable the Bluetooth connection automatically on both devices once the report data RD has been successfully transmitted from the measurement apparatus 2 to the mobile device 1. In a possible embodiment, the mobile device 1 can comprise a passive NFC tag which is recognized by an NFC device of the proximity detection unit 5. In a possible embodiment, the pairing between the Bluetooth wireless transceivers 6, 7 is performed by using out-of-band OOB communication provided by near field communication NFC which exchange information used in the pairing process. Using out-of-band OOB pairing with NFC enables pairing in that both devices simply get close other than requiring a lengthy discovery process.

In a possible embodiment, the measurement apparatus 2 can also comprise a WiFi proximity detection unit and/or a WiFi wireless transceiver. The received bidirectional wireless link 9 between the wireless transceiver 7 of the mobile device 1 and the wireless transceiver 6 of the measurement apparatus 2 can in a possible embodiment be symmetrically providing similar bandwidth in both directions. In a possible embodiment, the bidirectional wireless link 9 between the wireless transceiver 7 and the wireless transceiver 6 of the measurement apparatus is asymmetric providing more bandwidth for transmitting data from the measurement apparatus 2 to the mobile device 1 than for transmitting data from the mobile device 1 to the measurement apparatus 2. This embodiment has the advantage that extensive report data stored in the data memory 8 can be transmitted with a high bandwidth from the wireless transceiver 6 to the measurement apparatus 2 to the wireless transceiver 7 of the mobile device 1 while only a small bandwidth is required for transmitting signals such as a request signal sent from the wireless transceiver 7 via the wireless link 9 to the wireless transceiver 6 of the measurement apparatus 2. In a possible embodiment, the mobile device 1 has a master Bluetooth device which can communicate with seven slave devices formed by a measurement apparatus 2 in a piconet. In a possible embodiment, the master Bluetooth device can choose each slave to address. In a possible embodiment, the master Bluetooth device can switch from one slave device to another slave device in a round-robin fashion.

The presence of a wireless communication can be detected in different ways. In a possible embodiment, the proximity detection unit 5 is adapted to process various complex modulation schemes which are used by the different wireless standards to determine a WiFi device or Bluetooth device being in the vicinity of the proximity detection unit 5. In this embodiment, the proximity detection unit 5 is adapted to distinguish between the presence of a WiFi device and the presence of a Bluetooth device, even though they reside in the same frequency band.

In an alternative embodiment, the proximity detection unit 5 filters the signals in a predetermined frequency spectrum range and measures the power received by its antenna. If the received power is above a threshold value, the proximity detection unit 5 detects that there is some type of wireless communication going on in the respective frequency band. In this embodiment, the proximity detection unit 5 cannot distinguish between WiFi, Bluetooth or any other wireless communication. However, this embodiment has the advantage that the processing delay times are minimized. In a possible embodiment, the proximity detection unit 5 comprises a separate antenna connected to a band-pass filter BPF filtering signals in a predetermined frequency range, for instance in the 2.45 Gigahertz range, wherein the filtered signal is provided to a low-noise amplifier LNA which supplies the amplified signal to a power signal detector of the proximity detection unit 5.

The presence of the mobile device 1 in the vicinity of the measurement apparatus 2 can be detected by the proximity detection unit 5 in different ways. In a possible embodiment, the presence of the mobile device 1 is detected by evaluating a radio signal strength RSS of a specific radio signal received by the proximity detection unit 5 of the measurement apparatus 2 from the mobile device 1. This radio signal strength RSS technique is based on the propagation decay of a transmitted radio signal. The radio signal decays as it propagates through a medium.

In an alternative embodiment, the presence of the mobile device 1 in the vicinity of the measurement apparatus 2 is detected by evaluating a time of arrival TOA of a specific radio signal received by the proximity detection unit 5 of the measurement apparatus 2 from the mobile device 1. The TOA technique can be used when the transmitter and receiver time is synchronized. A sending time can be stamped on the same signal or an auxiliary signal transmitted at the same time. In this embodiment, when the mobile device 1 and the measurement apparatus 2 are synchronized, the propagation time of the signal can be calculated by subtracting the sending time of the signal from the arrival time.

In a still further possible alternative embodiment, the presence of the mobile device 1 is detected by evaluating a round trip time of flight of a specific radio signal transmitted by the proximity detection unit 5 of the measurement apparatus 2 and returned back to the proximity detection unit 5 of the measurement apparatus 2. In this embodiment, the transmitting device emits a signal to get it back from the other transceiver.

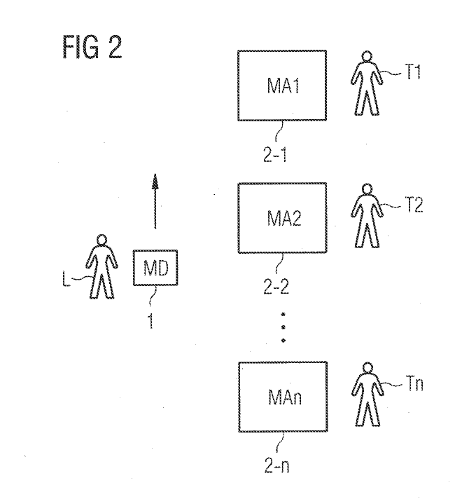

FIG. 2 shows a schematic diagram for illustrating a possible embodiment of a training system according to a further aspect of the present invention. In the illustrated training system, the training system comprises n measurement apparatuses 2-1, 2-2, . . . 2-i . . . 2-n operated by technicians Tᵢ. The training system comprises a mobile device 1 carried by a lecturer L who trains the technicians Tᵢ to operate the measurement apparatuses 2-i. The measurement apparatuses 2-i can be of the same type or different measurement apparatuses such as oscilloscopes, signal generators, signal analyzers, a testing device or network analyzers. Accordingly, the technicians Tᵢ can be trained to handle the same measurement apparatus or different kinds of measurement apparatuses. Each technician T has an associated measurement apparatus 2 to perform measurements at a measurement setup, wherein each measurement apparatus 2-i of the training system 1 is configured to trigger a wireless transceiver integrated in the measurement apparatus 2 to transmit automatically report data via at least one wireless link to the mobile device 1 of the lecturer if the presence of the lecturer's mobile device 1 in the vicinity of the measurement apparatus 2 is detected by the respective measurement apparatus 2-i. In a possible embodiment of the training system as illustrated in FIG. 2, each measurement apparatus 2-i is equipped with a proximity detection unit 5. If the proximity detection unit 5 of the measurement apparatus 2-i detects that the mobile device 1 is in the vicinity of the stationary measurement apparatus 2-i, report data RD stored in a memory of the measurement apparatus 2 is automatically transmitted via at least one wireless link from the measurement apparatus 2 to the mobile device 1 of the lecturer L. In a possible embodiment, the lecturer L can carry a smartphone or a laptop or an iPad which comprises an NFC device and taps his mobile device 1 on an NFC device of the proximity detection unit 5 to trigger the automatic transmission of report data RD to a memory of the mobile device 1. In a possible embodiment, the transmission of the report data RD can be performed, via a NFC wireless link with a low data transfer speed of e.g. 0.424 Mbps. In a preferred embodiment, after detection of the mobile device 1 of the lecturer L in the vicinity of the measurement apparatus 2, the proximity detection unit 5 automatically establishes the wireless Bluetooth connection between the transceivers of the measurement apparatus 2 and the mobile device 1. After having established the Bluetooth connection, report data RD is transmitted automatically via the established Bluetooth connection from the measurement apparatus 2 to the mobile device 1 with a higher data rate of e.g. 24 Mbps. A professor or lecturer L can in this way go from a first technician T to be trained to another technician and receive the report data RD of the first technician comprising for instance measurement results such as signal diagrams or measurement setup parameters or a text document written by the trained technician T. If the different technicians Tᵢ are trained on the same measurement apparatus 2, the lecturer L can select all report data received from the different technicians Tᵢ. The received report data, in particular measurement parameters, performed at the same test measurement setup can automatically be compared with each other, to identify technicians which need more training on the measurement apparatus 2-i.

In a possible embodiment, the mobile device 1 of the lecturer L is not only able to receive report data RD from the different measurement apparatuses 2-i, but also to provide measurement apparatus initial settings for the measurement setup to simulate a specific test situation. For instance, the lecturer L can set a measurement parameter of the measurement apparatus 2 in an unallowed parameter range to see, whether the technician T can handle this problem. The measurements can be performed in a training session which can be influenced in a possible embodiment by the lecturer L by changing the training situation and/or test setup 3.

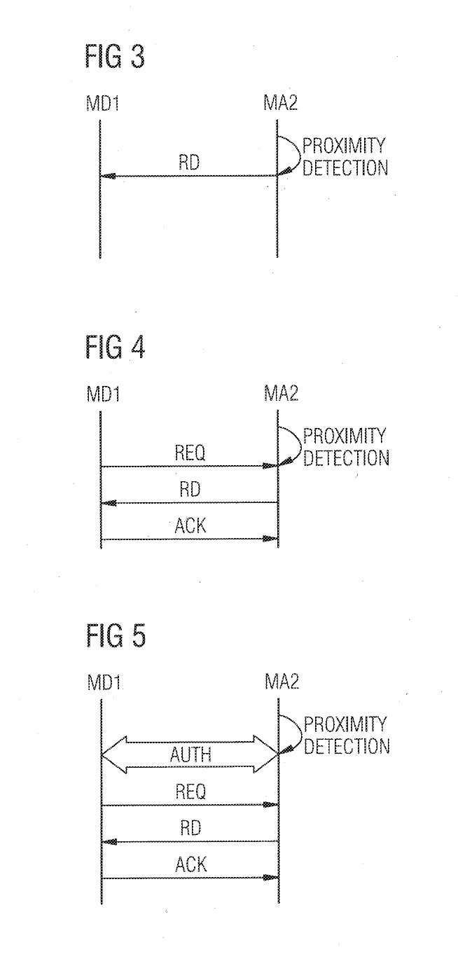

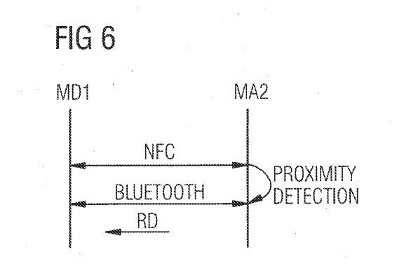

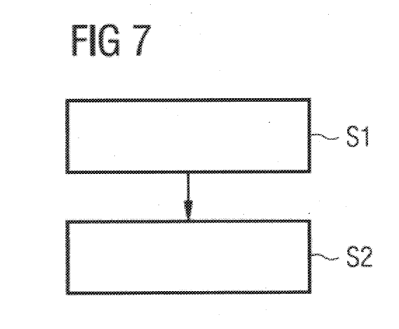

FIG. 3, 4, 5, 6 show signal diagrams for illustrating different exemplary embodiments of a method for providing a mobile device 1 with report data RD of a measurement apparatus 2 shown in the flow chart of FIG. 7. As can be seen in FIG. 7, a method for providing a mobile device 1 with report data RD of a measurement apparatus 2 can comprise in a possible embodiment two main steps.

In a first step S1, the presence of the mobile device 1 within the vicinity of the stationary measurement apparatus 2 can be detected, for instance by a proximity detection unit 5 of the measurement apparatus 2.

In a further step S2, report data RD is automatically transmitted via at least one wireless link from the stationary measurement apparatus 2 to the mobile device 1 upon detection of the presence of the mobile device 1 within the vicinity of the measurement apparatus 2.

FIG. 3 shows a signal diagram for illustrating a possible exemplary embodiment of the method according to the present invention. In FIG. 3, the proximity detection unit 5 of the measurement apparatus 2 detects that the mobile device 1 is in its vicinity and pushes automatically report data RD which can be stored in a memory of the measurement apparatus 2 to the mobile device via a wireless link.

In a further possible embodiment, after proximity detection, the measurement apparatus 2 further waits to receive a request signal REQ from the mobile device 1 before pushing report data RD via at least one wireless link 9 to the mobile device 1. Further, the mobile device 1 can return in the shown embodiment an acknowledgement signal ACK after successful transmission of the report data RD. In the embodiment shown in FIG. 4, the measurement apparatus 2 receives a request signal from the transceiver of the mobile device 1 for sending the report data via the wireless link 9.

In an alternative embodiment, the measurement apparatus 2 does not receive an explicit request signal, but detects a request on the basis of a specific detected tracked movement of the mobile device 1. In a possible embodiment, the proximity detection unit 5 of the measurement apparatus 2 is configured to track a movement of the mobile device 1 upon detection of its presence in the vicinity of the measurement apparatus 2. In this embodiment, the proximity detection unit 5 can detect a specific movement of the mobile device 1 to recognize that transmission of the report data RD is requested by the user of the mobile device 1. For example, the user of the mobile device 1 can turn his mobile device 1 around 360° so that the rotation of the mobile device 1 is recognized by the proximity detection unit 5 tracking the movement of the mobile device 1 so that the recognized movement pattern triggers automatically the transmission of the stored report data RD to the mobile device 1. In another possible embodiment, the mobile device 1 may comprise a sensor which is adapted to recognize a specific movement of the mobile device 1 to generate a corresponding request signal which is transmitted by a transceiver of the mobile device 1 to the transceiver of the measurement apparatus 2 triggering the transmission of the report data RD. In these embodiments, the user of the mobile device 1 such as a professor or lecturer L does not have to input any data into the user interface of the mobile device 1 for getting the report data RD from the measurement apparatus 2. In this embodiment, the lecturer L carries his mobile device 1 into the vicinity of the measurement apparatus 2 so that the presence of the mobile device 1 is detected and then performs a predetermined movement or movement pattern of the mobile device 1 which can be recognized by the measurement apparatus 2 to trigger the automatic transmission of the report data RD to the mobile device 1.

FIG. 5 shows a further possible embodiment of the method according to the present invention. In this embodiment, the mobile device 1 and the measurement apparatus 2 perform an authentication process after the presence of the mobile device 1 in the vicinity of the measurement apparatus 2 has been detected by the proximity detection unit 5 of the measurement apparatus 2. Only after successful authentication, the report data RD is automatically transmitted by the measurement apparatus 2 to the mobile device 1 in response to the received request signal or in response to a detected request on the basis of a specific tracked movement of the mobile device 1.

FIG. 6 shows a signal diagram for illustrating a specific embodiment of the method according to the present invention. After having established an NFC communication link between the mobile device 1 and the measurement apparatus 2, the proximity of the mobile device 1 is detected to generate a Bluetooth communication link for transmitting automatically report data RD from the measurement apparatus to the mobile device 1.

In a possible embodiment of the method according to the present invention, the measurement apparatus 2 comprises an encryption unit encrypting the report data RD for transmitting the report data to the mobile device 1. In this embodiment, the mobile device 1 comprises a decryption unit decrypting the received encrypted report data and then storing the received report data and/or processing the received decrypted report data.

In a possible embodiment, the detection range of the proximity detection unit 5 of the measurement apparatus 2 can be adjusted. In a possible embodiment, the detection range of the proximity detection unit 5 is less than 20 cm. After having detected the presence of the mobile device 1, for instance by NFC communication, a switchover to another wireless transmission protocol can be performed having a higher range such as Bluetooth with a transmission range of about 100 m. In this embodiment, a lecturer L after having tapped on the NFC device of the proximity detection unit 5 to indicate the presence of his mobile device 1 may walk on to the next technician T and receive report data of the first technician during walking to the next measurement apparatus 2 of the next technician to be trained. Accordingly, the supervisory person such as the lecturer L does not have to wait in the vicinity of the measurement apparatus 2 after the proximity detection has been accomplished but receives the report data RD because of the increased transmission range over a wireless communication protocol having a higher range. NFC has a lower transfer rate than Bluetooth. By using NFC instead of performing manual configurations to identify devices, the connection between two NFC devices is automatically established in less than tenths of a second. A maximum data transfer rate of NFC (724 kbps) is however slower than that of Bluetooth, e.g. 2.1 Mbps. With a maximum working distance of less than 20 cm, NFC has a shorter range which reduces the likelihood of unwanted interception.

The transmission of report data via RD the wireless link 9 can be performed in different ways. In a possible embodiment, the report data RD is transmitted in data packets according to a predetermined wireless transmission protocol. In an alternative embodiment, the report data can also be transferred in predetermined time slots. In a possible embodiment, the proximity detection unit 5 is configured to track the movement of the mobile device 1, i.e. whether it is moving away from the measurement apparatus 2 or comes closer or standing idle. When the distance is deemed within a certain radius R as well as being constant for a predetermined time frame, the measurement apparatus 2 can automatically push the report data RD preconfigured on the measurement apparatus 2 such as an instrument setup, measurement results or more comprehensive reports to be transmitted over to the wireless transceiver 7 of the mobile device 1. In a possible embodiment, the report data RD is pushed by the measurement apparatus 2 to the mobile device 1. In an alternative embodiment, the report data can also be pulled by the mobile device 1 from the measurement apparatus 2.

In the foregoing specification, the invention has been described with reference to specific examples of the embodiments of the invention. It will, however, be evident that various notifications and changes may be made therein without departing from the broader spirit and scope of the present invention as set forth in the appended claims. For example, the connections may be a type of connections suitable to transfer signals from or to the respective nodes, units or devices, for example via intermediate devices. Accordingly, unless implied or stated otherwise, the connections may be for example be direct connections or indirect connections.

For the devices implemented in the present invention are for the most part composed of electronic components and circuits known for those skilled in the art, details of the circuitry and its components will not be explained in any greater extent than that considered necessary as illustrated above, for the understanding and appreciation of the underlying concept of the present invention and in order not to obfuscate or distract from the teachings of the present invention.

Moreover, the present invention is not limited to physical devices or units implemented in non-programmable hardware but can also be applied in programmable devices or units able to perform the desired device functions or operating in accordance with suitable program code. Furthermore, the devices may be physically distributed over a number of apparatuses, or they are functionally operating as a single device. Devices and functions forming separate devices may be integrated in a single physical device.

In the description, any reference signs shall not be construed as limiting the claims. The term “comprising” does not exclude the presence of other elements or steps listed in the claim. Furthermore, the terms “a” or “an” as used herein are defined as one or more than one. Also, the use of introductory phrases such as “at least one” and “one or more” in the claims should not be construed to imply that the introduction of another claim element by the indefinite articles “a” or “an” limiting any particular claim containing such introduced claim element to inventions containing only one such element. The same holds true for the use of definite articles. Unless stated otherwise, terms such as “first” and “second” are used to arbitrarily distinguish between the elements such terms describe. The mere fact that certain measures are recited in different claims does not indicate that a combination of these measures cannot be used to advantage. The order of method steps presented in a claim does not prejudice the order in which the steps can actually be carried out, unless specifically recited in the claim.

The skilled artisans will appreciate that elements in the figures are illustrated for simplicity and clarity and have not necessarily drawn to scale. For example, the chosen elements are only used to help to improve the understanding of the functionality and the arrangements of these elements in various embodiments of the present invention. Also, common but well-understood elements that are useful or necessary in a commercial and feasible embodiment are mostly not depicted in order to facilitate a less abstracted view of these various embodiments of the present invention.

### LIST OF REFERENCE SIGNS

1 mobile device
2 measurement apparatus
3 measurement setup
4 user interface
5 proximity detection unit
6 wireless transceiver
7 wireless transceiver
8 report data memory
9 wireless link

1. A stationary measurement apparatus for providing a mobile device with report data transmitted automatically via at least one wireless link from said stationary measurement apparatus to the mobile device if it is detected that the mobile device is in a vicinity of the stationary measurement apparatus.

2. The stationary measurement apparatus according to claim 1, wherein a proximity detection unit of the measurement apparatus and/or mobile device is configured to detect that the mobile device is in the vicinity of the stationary measurement apparatus, said proximity detection unit comprising
a near field communication, NFC, proximity detection unit and/or
a Bluetooth proximity detection unit and/or
a WiFi proximity detection unit.

3. The stationary measurement apparatus according to claim 1, wherein the measurement apparatus comprises a user interface operated by a technician to be trained to generate report data transmitted via the wireless link to the mobile device of a lecturer.

4. The stationary measurement apparatus according to claim 1, wherein the proximity detection unit is configured to track a movement of the mobile device upon detection of the presence of the mobile device in the vicinity of the stationary measurement apparatus.

5. The stationary measurement apparatus according to claim 1, wherein the proximity detection unit is configured to generate a trigger signal if the mobile device is within a predetermined radius of the measurement apparatus, wherein the generated trigger signal is applied to a wireless transceiver of the measurement apparatus to automatically push the report data via the wireless link to the mobile device.

6. The stationary measurement apparatus according to claim 1, wherein the report data comprises a text document, an instrument setup of the measurement apparatus and/or measurement results stored in a memory of the stationary measurement apparatus.

7. The stationary measurement apparatus according to claim 6 comprising a wireless transceiver configured to automatically transmit the instrument setup of the measurement apparatus, a measurement result and/or a text document stored in the memory of the measurement apparatus via the wireless link to the mobile device if the proximity detection unit detects that a mobile device is within a predetermined radius of the measurement apparatus.

8. A mobile device comprising a wireless transceiver adapted to receive via at least one wireless link report data transmitted automatically by a stationary measurement apparatus to said mobile device upon detection of the presence of the mobile device in the vicinity of the measurement apparatus.

9. A method for providing a mobile device with report data, the method comprising:
(a) detecting a presence of the mobile device within a vicinity of a stationary measurement apparatus, and
(b) transmitting automatically report data via at least one wireless link from the stationary measurement apparatus to the mobile device upon detection of the presence of the mobile device within the vicinity of the stationary measurement apparatus.

10. The method according to claim 9, wherein the measurement apparatus is operated via a user interface of said measurement apparatus by a technician to be trained to generate report data transmitted automatically via the wireless link to a mobile device of a lecturer training said technician.

11. The method according to claim 9, wherein the presence of the mobile device in the vicinity of the measurement apparatus is detected by wireless near field communication, NFC, between the mobile device and the measurement apparatus.

12. The method according to claim 11, wherein after detection of the mobile device in the vicinity of the measurement apparatus a wireless Bluetooth connection between the measurement apparatus and the mobile device is automatically established to transmit report data via the established Bluetooth connection from the measurement apparatus to the mobile device.

13. The method according to claim 12, wherein the Bluetooth connection is automatically disabled after successful transmission of the report data to the mobile device.

14. The method according to claim 9, wherein the report data is transmitted from the measurement apparatus to the mobile device after successful authentication of the mobile device and/or upon having received or having detected a request for transmission of said report data.

15. The method according to claim 14, wherein the request for transmission of the report data is generated by a proximity detection unit of the mobile device and/or measurement apparatus in response to a specific detected tracked movement of the mobile device.

16. The method according to claim 9, wherein the report data is encrypted by an encryption unit of the measurement apparatus and transmitted by a transceiver of the measurement apparatus to the mobile device in encrypted form.

17. The method according to claim 9, wherein the successful transmission of the transmitted report data from the measurement apparatus to the mobile device is acknowledged by the mobile device by returning an acknowledgement signal to the measurement apparatus.

18. The method according to claim 9, wherein the presence of the mobile device is detected by evaluating a radio signal strength of a specific radio signal received by a proximity detection unit of the measurement apparatus from the mobile device or
the presence of the mobile device is detected by evaluating a time of arrival of a specific radio signal received by a proximity detection unit of the measurement apparatus from the mobile device or
the presence of the mobile device is detected by evaluating a round trip time of flight of a specific radio signal transmitted by a proximity detection unit of the measurement apparatus and returned back to the proximity detection unit of the measurement apparatus.

19. A training system for training technicians to handle a measurement apparatus,
wherein each technician handles an associated measurement apparatus during training to perform measurements,
wherein said measurement apparatus is configured to trigger a wireless transceiver of the measurement apparatus to transmit automatically report data relating to the performed measurements of the trained technician via at least one wireless link to the mobile device of a lecturer if a presence of the lecturer's mobile device in a vicinity of the measurement apparatus is detected by the respective measurement apparatus and/or by the mobile device.

20. The training system according to claim 19, wherein the measurement apparatus of the trained technician comprises an oscilloscope, a signal generator, a signal analyzer, a network analyzer and/or a testing device.
